(19) United States
(12) Patent Application Publication
(10) Pub. No.: US 2010/0035156 A1
(43) Pub. Date: Feb. 11, 2010

(54) BATTERY ELECTRODE PLATE HAVING EVEN THERMAL DISTRIBUTION

(76) Inventor: Kurtis C. Kelley, Washington, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/522,766

(22) PCT Filed: Jan. 11, 2008
(86) PCT No.: PCT/US08/00439

§ 371 Date: Jul. 10, 2009

Related U.S. Application Data
(60) Provisional application No. 60/880,029, filed on Jan. 12, 2007.

(51) Int. Cl. H01M 4/57; H01M 4/56

(52) U.S. Cl. 429/228; 429/225

(57) ABSTRACT

An electrode plate (44) for a lead-acid battery (10) is disclosed. The electrode plate includes a current-collecting first layer (48). In addition, the electrode plate also includes a second layer (50) comprising flexible graphite sheeting (52) and configured to distribute thermal energy within the electrode plate. Further, the electrode plate includes a third layer (48, 62), wherein the second layer is disposed between the current-collecting first layer and the third layer.

### PRIORITY

The present application claims the benefit of priority to U.S. provisional patent application No. 60/880,029, filed Jan. 12, 2007, the entire disclosure of which is incorporated herein by reference.

### TECHNICAL FIELD

The present disclosure is directed to a battery electrode plate and, more particularly, to a battery electrode plate having even thermal distribution.

### BACKGROUND

Lead-acid batteries are known to include at least one positive current collector, at least one negative current collector, and an electrolytic solution including, for example, sulfuric acid (H₂SO₄) and distilled water. Ordinarily, both the positive and negative current collectors in a lead-acid battery are constructed from lead. The role of these lead current collectors is to transfer electric current to and from the battery terminals during the discharge and charging processes. Storage and release of electrical energy in lead-acid batteries is enabled by chemical reactions that occur in a paste disposed on the current collectors. The positive and negative current collectors, once coated with this paste, are referred to as positive and negative plates, respectively. Other configurations of positive and/or negative plates are also known.

A key property influencing the life and performance of lead-acid batteries (for example) is the thermal diffusivity of the individual plates. As charge and discharge reactions occur, heat is generated in areas of the plates for various reasons. If the temperature of one region of a plate is different from another part, an imbalance of activity will occur. This will often result in the warmer region of the plate being more active, which causes this region to become even more active and to heat more, and so on. In addition, the opposing plate responds in kind, and mirrors the non-uniform distribution of active areas found on the first plate. This phenomenon, similar to a thermal runaway, can cause the battery electrode plate to overwork in some areas and under-work in others. The battery performance can suffer from degradation due to uneven temperatures in the plates. The hottest, and thus overworked, areas degrade soonest and limit the life of the battery.

Graphite foam electrodes may resolve this problem by using the high thermal-diffusivity of graphite foam to distribute heat throughout the entire area of the plate. Using graphite foams in positive and/or negative plates can improve battery life. In some cases, using the graphite foam in only one of the plates (e.g., the negative plate) of an electrode plate pair may cause an opposing, traditional plate (e.g., a positive plate fabricated without a graphite foam thermal diffuser element) to use its entire active surface uniformly, resulting in longer runtime and extended battery life.

However, graphite foam is a relatively expensive material, and thus, there is a strong incentive to replace the graphite foam with a different material, for example, carbon foam. While carbon foam has the lightweight and corrosion resistant characteristics of graphite foam, the carbon foam does not have the high thermal-diffusivity of graphite foam. Thus, there is a need for structures for improving the thermal diffusion properties of a battery electrode plate including carbon foam or any other materials having thermal diffusion efficiencies lower than a desired level.

U.S. Patent Application Publication No. 2006/0292448 by Gyenge et al. discloses a current collector of a battery including a carbon foam material or a graphite foam material. These two materials are discussed in the alternative, and thus, are not disclosed to be used together in the same embodiment. Therefore, embodiments of the '448 publication that utilize the carbon foam material may lack strength. Embodiments of the '448 publication that utilize the graphite foam material may have better strength, but will be relatively expensive.

The present disclosure is directed at improvements in existing electrode plates for batteries.

### SUMMARY

In one aspect, the present disclosure is directed to an electrode plate for a lead-acid battery. The electrode plate may include a current-collecting first layer. In addition, the electrode plate may also include a second layer comprising flexible graphite sheeting and configured to distribute thermal energy within the electrode plate. Further, the electrode plate may include a third layer, wherein the second layer is disposed between the current-collecting first layer and the third layer.

In another aspect, the present disclosure is directed to another electrode plate for a lead-acid battery. Also, the electrode plate may include a current-collecting, carbon foam first layer. Further, the electrode plate may also include a second layer comprising flexible graphite sheeting and configured to distribute thermal energy within the electrode plate.

In another aspect, the present disclosure is directed to an electrode plate for a battery. The electrode plate may include a current-collecting first layer. In addition, the electrode plate may also include a second layer comprising flexible graphite sheeting and configured to distribute thermal energy within the electrode plate. Further, the flexible graphite sheeting may include a perforated sheet or grid.

### BRIEF DESCRIPTION OF THE DRAWINGS

FIG. 1 is a diagrammatic cut-away representation of a battery according to an exemplary disclosed embodiment.

FIG. 2A is a plan view of a current collector in accordance with an exemplary disclosed embodiment.

FIG. 2B is a close-up view of the current collector of FIG. 2A.

FIG. 3 is a plan view of a carbon foam structure according to an exemplary disclosed embodiment.

FIG. 4 is a magnified diagrammatic representation of an exemplary carbon foam structure.

FIG. 5 is a cross-sectional view of an electrode plate according to an exemplary disclosed embodiment.

FIG. 6 is a cross-sectional view of an electrode plate according to another exemplary disclosed embodiment.

FIG. 7 is a cross-sectional view of an electrode plate according to another exemplary disclosed embodiment.

FIG. 8 is a cross-sectional view of an electrode plate according to another exemplary disclosed embodiment.

### DETAILED DESCRIPTION

Reference will now be made in detail to the drawings. Wherever possible, the same reference numbers will be used throughout the drawings to refer to the same or like parts.

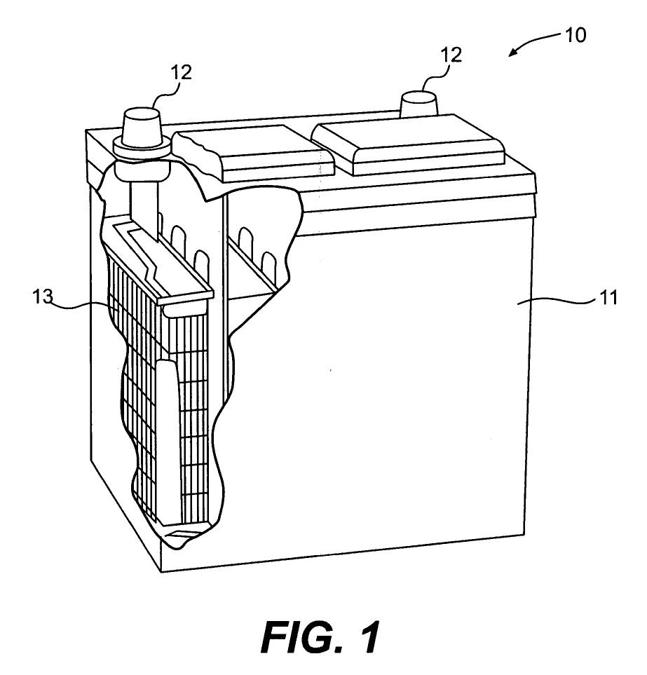

FIG. 1 illustrates a battery 10 in accordance with an exemplary disclosed embodiment. Battery 10 includes a housing 11 and terminals 12, which are external to housing 11. At least one cell 13 is disposed within housing 11. While only one cell 13 is necessary, multiple cells may be connected in series or in parallel to provide a desired total potential of battery 10.

Each cell 13 may be composed of alternating positive and negative plates immersed in an electrolytic solution. The electrolytic solution composition may be chosen to correspond with a particular battery chemistry. For example, while lead-acid batteries may include an electrolytic solution of sulfuric acid and distilled water, nickel-based batteries may include alkaline electrolyte solutions that include a base, such as potassium hydroxide, mixed with water. It should be noted that other acids and other bases may be used to form the electrolytic solutions of the disclosed batteries.

The positive and negative plates of each cell 13 may include a current collector packed or coated with a chemically active material. The composition of the chemically active material may depend on the chemistry of battery 10. For example, lead-acid batteries may include a chemically active material including, for example, an oxide or salt of lead. Further, the anode plates (i.e., positive plates) of nickel cadmium (NiCd) batteries may include cadmium hydroxide (Cd(OH)₂) material; nickel metal hydride batteries may include lanthanum nickel (LaNi₅) material; nickel zinc (NiZn) batteries may include zinc hydroxide (Zn(OH)₂) material; and nickel iron (NiFe) batteries may include iron hydroxide (Fe(OH)₂) material. In all of the nickel-based batteries, the chemically active material on the cathode (i.e., negative) plate may be nickel hydroxide.

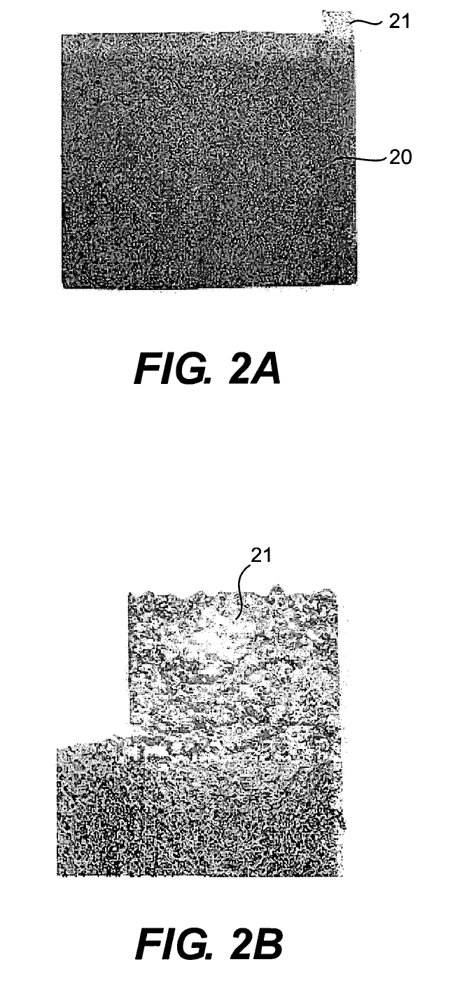

FIG. 2A illustrates a current collector 20 according to an exemplary embodiment. As shown, current collector 20 may include a thin, rectangular body and a tab 21 used to form an electrical connection with current collector 20.

The current collector shown in FIG. 2A may be used to form either a positive or a negative plate. As previously stated, chemical reactions in the active material disposed on the current collectors of the battery enable storage and release of energy. The composition of this active material, and not the current collector material, determines whether a given current collector functions as either a positive or a negative plate.

While the type of plate, whether positive or negative, does not depend on the material selected for current collector 20, the current collector material and configuration affects the characteristics and performance of battery 10. For example, during the charging and discharging processes, each current collector 20 transfers the resulting electric current to and from battery terminals 12. In order to efficiently transfer current to and from terminals 12, at least a portion of current collector 20 must be formed from an electrically conductive material. In addition to the material selected for the current collector 20, the configuration of current collector 20 is also a factor in battery performance. For instance, the amount of surface area available on current collector 20 may influence the specific energy, specific power, and the charge/discharge rates of battery 10.

In an exemplary embodiment, current collector 20, as shown in FIG. 2A, may be formed from of a carbon foam material, which may include carbon or carbon-based materials that exhibit some degree of porosity. Because the foam may be carbon or carbon-based, it may resist corrosion even when exposed to electrolytes and to the electrical potentials of the positive or negative plates. The carbon foam may include a network of pores, which provides a large amount of surface area for each current collector 20. For example, some current collectors composed of carbon foam may exhibit more than 2000 times the amount of surface area provided by other types of current collectors.

The disclosed foam material may include any carbon-based material having a reticulated pattern including a three-dimensional network of struts and pores. The foam may comprise naturally occurring and/or artificially derived materials.

FIG. 2B illustrates a closer view of tab 21, which may be formed on current collector 20. Tab 21 may be coated with a conductive material and used to form an electrical connection with the current collector 20. The conductive material used to coat tab 21 may include a metal that is more conductive than the carbon foam current collector. Coating tab 21 with a conductive material may provide structural support for tab 21 and may create a suitable electrical connection capable of handling the high currents that may be present in lead-acid and nickel-based batteries.

Other suitable configurations for establishing electrical connections with current collector 20 may be used. For example, alternatives to tabs such as tab 21 may include any suitable configurations for providing an electrical connection to current collector 20. Further, in the case of a bi-polar battery architecture, a tab may omitted.

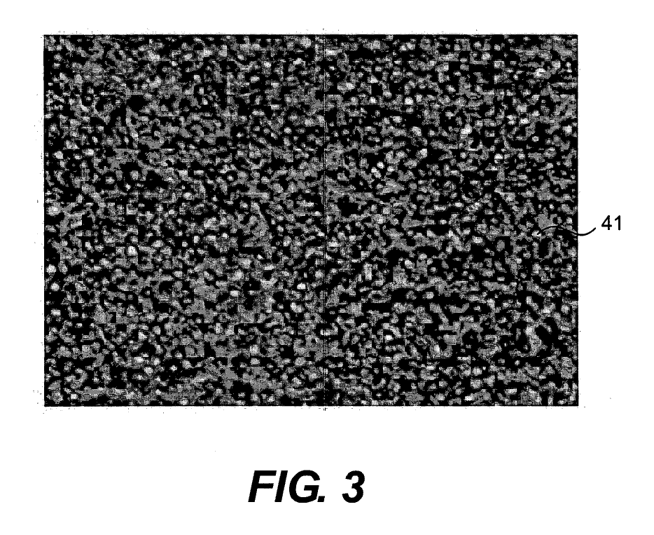

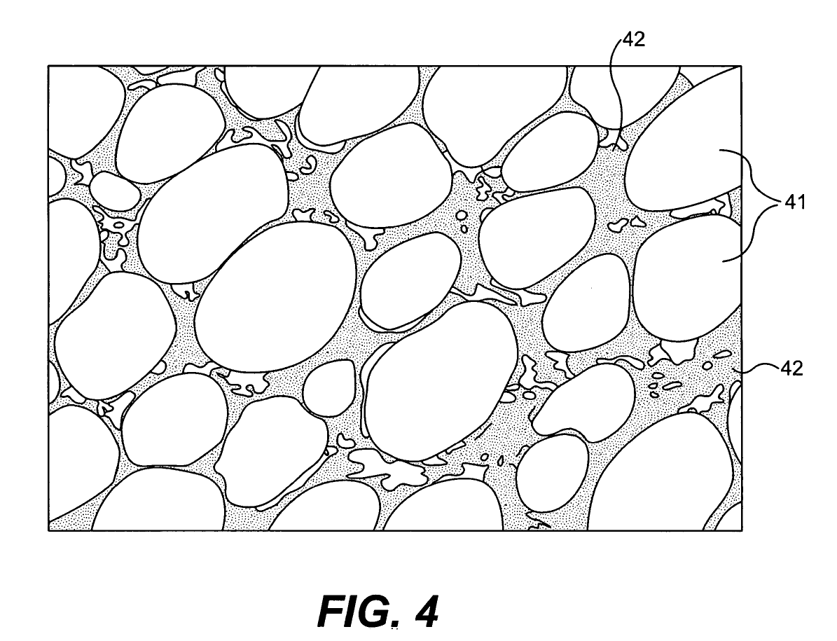

FIG. 3 provides a view, at approximately 10× magnification, of an exemplary current collector 20, including an exemplary network of pores. FIG. 4 provides an even more detailed representation (approximately 100× magnification) of the network of pores. In one embodiment, the carbon foam may include from about 4 to about 50 pores per centimeter and an average pore size of at least about 200 μm. In other embodiments, however, the average pore size may be smaller. For example, in certain embodiments, the average pore size may be at least about 20 μm. In still other embodiments, the average pore size may be at least about 40 μm.

Regardless of the average pore size, a total porosity value for the carbon foam may be at least 60%. In other words, at least 60% of the volume of the carbon foam structure may be included within pores 41. Carbon foam materials may also have total porosity values less than 60%. For example, in certain embodiments, the carbon foam may have a total porosity value of at least 30%.

Moreover, the carbon foam may have an open porosity value of at least 90%. Therefore, at least 90% of pores 41 are open to adjacent pores such that the network of pores 41 forms a substantially open network. This open network of pores 41 may allow the active material deposited on each current collector 20 to penetrate within the carbon foam structure. In addition to the network of pores 41, the carbon foam includes a web of structural elements 42 that provide support for the carbon foam. In total, the network of pores 41 and the structural elements 42 of the carbon foam may result in a density of less than about 0.6 gm/cm³ for the carbon foam material.

Due to either the conductivity of carbon foam or to a secondary collector material and/or the conductivity of the active material, current collectors 20 can efficiently transfer current to and from the battery terminals 12, or any other conductive elements providing access to the electrical potential of battery 10. In certain forms, the carbon foam may offer sheet resistivity values of less than about 1 ohm-cm. In still other forms, the carbon foam may have sheet resistivity values of less than about 0.75 ohm-cm.

In addition to carbon foam, graphite foam may also be used to form current collector 20. One such graphite foam, under the trade name PocoFoam™, is available from Poco Graphite, Inc. The density and pore structure of graphite foam may be similar to carbon foam. A primary difference between graphite foam and carbon foam is the orientation of the carbon atoms that make up the structural elements 42. For example, in carbon foam, the carbon may be at least partially amorphous. In graphite foam, however, much of the carbon is ordered into a layered, graphite structure. Because of the ordered nature of the graphite structure, graphite foam may offer higher thermal and electrical conductivity than carbon foam. Graphite foam may exhibit electrical resistivity values of between about 100 micro ohm-cm and about 2500 micro ohm-cm. Graphite foam may also have a higher thermal diffusivity than carbon foam.

In some embodiments, the carbon and/or graphite foams may be obtained by subjecting various organic materials to a carbonizing and/or graphitizing process. In one exemplary embodiment, various wood species may be carbonized and/or graphitized to yield the carbon foam material for current collector 20. Wood includes a naturally occurring network of pores. These pores may be elongated and linearly oriented. Moreover, pores in wood may form a substantially open structure, which gives wood its water-carrying properties. Certain wood species may offer an open porosity value of at least about 90% and the average pore size of wood may vary among different wood species. In an exemplary disclosed embodiment, the wood used to form the carbon foam material may have an average pore size of at least about 20 microns.

Any of a number of wood species may be used to form the carbon foam of the disclosed embodiments. For example, most hardwoods have pore structures suitable for use in the disclosed carbon foam current collectors. Exemplary wood species that may be used to create the carbon foam include oak, mahogony, teak, hickory, elm, sassafras, bubinga, palms, and many other types of wood species.

In some embodiments, the wood selected for use in creating the carbon foam may originate from tropical growing areas. For example, unlike wood grown in climates with significant seasonal variation, wood from tropical regions may have a less defined growth ring structure. As a result, the porous network of wood from tropical areas may lack certain non-uniformities that can result from the presence of growth rings.

To provide the carbon foam, wood may be subjected to a carbonization process to create carbonized wood (e.g., a carbon foam material). For example, heating of the wood to a temperature of between about 800° C. and about 1400° C. may have the effect of expelling volatile components from the wood. The wood may be maintained in this temperature range for a time sufficient to convert at least a portion of the wood to a carbon matrix. This carbonized wood will include the original porous structure of the wood. As a result of its carbon matrix, however, the carbonized wood can be electrically conductive and resistant to corrosion. During the carbonization process, the wood may be heated and cooled at any desired rate. In at least one embodiment, however, the wood may be heated and cooled sufficiently slowly to minimize or prevent cracking of the wood/carbonized wood. Also, heating of the wood may occur in an inert environment.

The carbonized wood may be used to form current collectors 20 without additional processing. Optionally, however, the carbonized wood may be subjected to a graphitization process to create graphitized wood (e.g., a graphite foam material). Graphitized wood is carbonized wood in which at least a portion of the carbon matrix has been converted to a graphite matrix. As previously noted, the graphite structure may exhibit increased electrical conductivity as compared to non-graphite carbon structures. Graphitizing the carbonized wood may be accomplished by heating the carbonized wood to a temperature of between about 2400° C. and about 3000° C. for a time sufficient to convert at least a portion of the carbon matrix of the carbonized wood to a graphite matrix. Heating and cooling of the carbonized wood may proceed at any desired rate. In at least one embodiment, however, the carbonized wood may be heated and cooled sufficiently slowly to minimize or prevent cracking. Also, heating of the carbonized wood may occur in an inert environment.

In an exemplary embodiment, portions of current collector 20 may be made from either carbon foam or from graphite foam. In certain battery chemistries, however, either the current collector of the positive plate or the current collector of the negative plate may be formed, at least in part, of a material other than carbon or graphite foam. For example, in lead-acid batteries, the current collector of the negative plate may include lead or another suitable conductive material. In other battery chemistries (e.g., nickel-based batteries), the current collector of the positive plate may be formed of a conductive material other than carbon or graphite foam.

The process for making an electrode plate for a battery according to one embodiment can begin by forming current collector 20. In one embodiment, the carbon foam material used to form current collector 20 may be fabricated or acquired in the desired dimensions of current collector 20. Alternatively, however, the carbon foam material may be fabricated or acquired in bulk form and subsequently machined to form the current collectors.

While any form of machining, such as, for example, band sawing and waterjet cutting, may be used to form the current collectors from the bulk carbon foam, wire EDM (electrical discharge machining) provides a method that may better preserve the open-cell structure of the carbon foam. In wire EDM, conductive materials are cut with a thin wire surrounded by de-ionized water. There is no physical contact between the wire and the part being machined. Rather, the wire is rapidly charged to a predetermined voltage, which causes a spark to bridge a gap between the wire and the work piece. As a result, a small portion of the work piece melts. The de-ionized water then cools and flushes away the small particles of the melted work piece. Because no cutting forces are generated by wire EDM, the carbon foam may be machined without causing the network of pores 41 to collapse. By preserving pores 41 on the surface of the current collector, chemically active materials may penetrate more easily into current collector 20.

As shown in FIG. 2A, current collector 20 may include tab 21 used to form an electrical connection to current collector 20. In certain applications, the electrical connection of current collector 20 may carry currents up to about 100 amps or more. In order to form an appropriate electrical connection capable of carrying such currents, the carbon foam that forms tab 21 may be pre-treated by a method that causes a conductive material, such as a metal, to wet the carbon foam. Such methods may include, for example, electroplating and thermal spray techniques. While both of these techniques may be suitable, thermal spray may offer the added benefit of enabling the conductive metal to penetrate deeper into the porous network of the carbon foam. In an exemplary embodiment, silver may be applied to tab 21 by thermal spray to form a carbon-metal interface. In addition to silver, other conductive materials may be used to form the carbon-metal interface depending on a particular application.

Once a carbon-metal interface has been established at tab 21, a second conductive material may be added to the tab 21 to complete the electrical connection. For example, a metal such as lead may be applied to tab 21. In an exemplary embodiment, lead may be used to wet the silver-treated carbon foam in a manner that allows enough lead to be deposited on tab 21 to form a suitable electrical connection.

A chemically active material, in the form of a paste or a slurry, for example, may be applied to current collector 20 such that the active material penetrates the network of pores in the carbon foam. It should be noted that the chemically active material may penetrate one, some, or all of the pores in the carbon foam. One exemplary method for applying a chemically active material to current collector 20 includes spreading a paste onto a transfer sheet, folding the transfer sheet including the paste over the current collector 20, and applying pressure to the transfer sheet to force the chemically active paste into pores 41. Pressure for forcing the paste into pores 41 may be applied by a roller, mechanical press, or other suitable device. Still another method for applying a chemically active material to current collector 20 may include dipping, painting, or otherwise coating current collector 20 with a slurry of active material. This slurry may flow into pores 41 to coat internal and external surfaces of current collector 20.

As noted above, the composition of the chemically active material used on current collector 20 depends on the chemistry of battery 10. For example, in lead-acid batteries, the chemically active material that is applied to current collector 20 of both the positive and negative plates may be substantially the same in terms of chemical composition. This chemically active material may include, for example, lead oxide (PbO), or other oxides and salts of lead.

The chemically active material may also include various additives including, for example, varying percentages of free lead, structural fibers, conductive materials, carbon, and extenders to accommodate volume changes over the life of the battery. In certain embodiments, the constituents of the chemically active material for lead-acid batteries may be mixed with sulfuric acid and water to form a paste, slurry, or any other type of coating material that may be disposed within pores 41 of current collector 20.

The chemically active material used on current collectors of nickel-based batteries may include various compositions depending on the type of battery and whether the material is to be used on a positive or negative plate. For example, the positive plates may include a cadmium hydroxide (Cd(OH)₂) active material in NiCd batteries, a lanthanum nickel (LaNi₅) active material in nickel metal hydride batteries, a zinc hydroxide (Zn(OH)₂) active material in nickel zinc (NiZn) batteries, and an iron hydroxide (Fe(OH)₂) active material in nickel iron (NiFe) batteries.

In all nickel-based batteries, the chemically active material disposed on the negative plate may be nickel hydroxide. For both the positive and negative plates in nickel-based batteries, the chemically active material may be applied to the current collectors as, for example, a slurry, a paste, or any other appropriate coating material.

Depositing the chemically active material on current collectors 20 may form the positive and negative plates of battery 10. In certain embodiments, the chemically active materials deposited on current collectors 20 may be subjected to curing and/or drying processes. For example, a curing process may include exposing the chemically active materials to elevated temperature and/or humidity to encourage a change in the chemical and/or physical properties of the chemically active materials.

After assembling together the positive and negative plates to form the cells of battery 10 (shown in FIG. 1), battery 10 may be subjected to a charging (i.e., formation) process. During this charging process, the composition of the chemically active materials may change to a state that provides an electrochemical potential between the positive and negative plates of the cells. For example, in a lead-acid battery, the PbO active material of the positive plate may be electrically driven to lead dioxide (PbO₂), and the active material of the negative plate may be converted to sponge lead. Conversely, during subsequent discharge of a lead-acid battery, the chemically active materials of both the positive and negative plates convert toward lead sulfate. Analogous chemical dynamics are associated with the charging and discharging of other battery chemistries, including nickel-based batteries, for example.

In order to evenly distribute heat throughout an electrode plate, a thermally conductive element may be included as part of the plate structure. Although several exemplary embodiments are shown and discussed herein, any structural configuration that incorporates a thermally conductive element capable of distributing thermal energy within the electrode plate may be used.

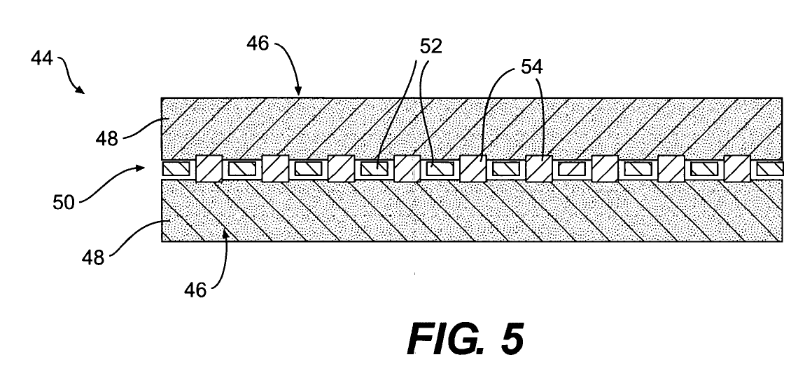

FIG. 5 illustrates a cross-section of an exemplary electrode plate 44. In some embodiments, plate 44 may include a current collector 46 formed of at least one carbon foam layer 48. In some embodiments, plate 44 may include a sandwich structure of more than one carbon foam layer, as shown in FIG. 5.

Plate 44 may also include a thermally conductive element configured to evenly distribute thermal energy throughout the electrode plate. The thermally conductive element may include, for example, a flexible carbon sheet layer 50. In some embodiments, the flexible carbon sheet may be in the form of a perforated sheet or a grid. In certain embodiments, the thermally conductive element may include graphite. For example, graphite sheets (a.k.a., graphite sheeting), grids, screens, felts, fabrics, foils, ribbons, etc. may be obtained and incorporated into the electrode plate structure. One suitable material for use in the electrode plate structure includes Grafoil™.

The thermally conductive element may be disposed in any suitable location to evenly distribute the thermal energy. For example, as shown in FIG. 5, the thermally conductive element may be located between carbon foam layers 48. As shown in FIG. 5, plate 44 may include a graphite grid 52 and a lead grid 54. In some embodiments, graphite grid 52 may be aligned offset from lead grid 54, as shown in FIG. 5. Lead grid 54 may be provided for structural support of the carbon foam layers 48. In some embodiments, lead grid 54 may be omitted. In other embodiments, more than one lead grid may be present.

The thermally conductive element may be bonded to one or more other constituents of the electrode plate through any suitable bonding process (lamination, melting, adhesives, etc.). Alternatively, the thermally conductive element can be placed in physical contact with the electrode plate without a physical bonding process.

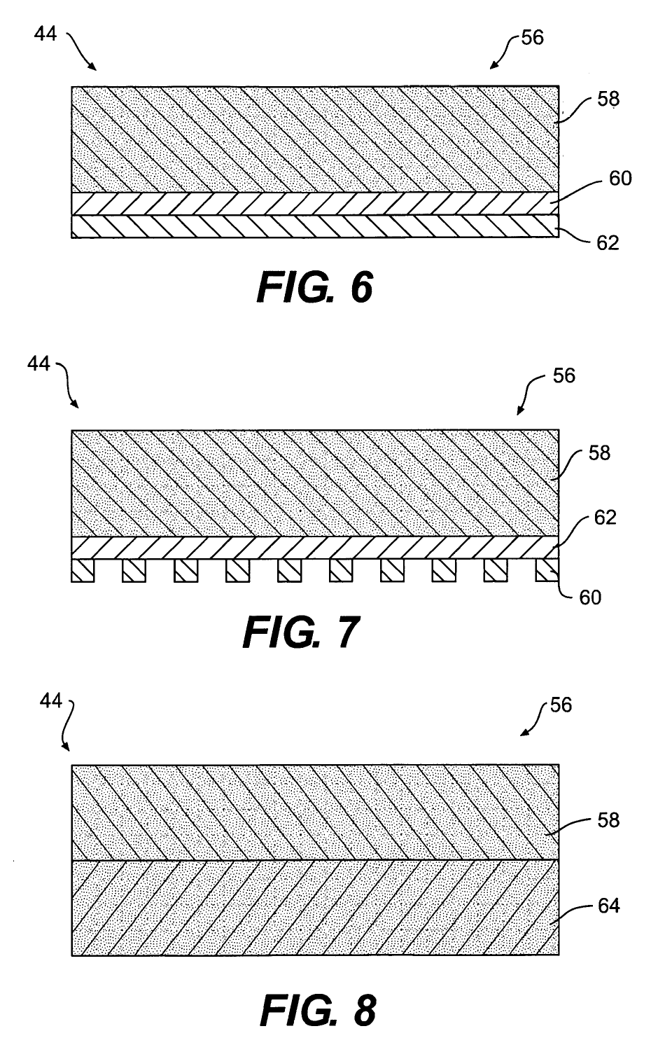

In other embodiments, such as shown in FIG. 6, the thermally conductive material may be disposed on an outer surface of a current collector 56. Current collector 56 may include, for example, a carbon foam layer 58. In some embodiments, the thermally conductive element may include a graphite sheet 60 or other thermally conductive material disposed between current collector 56 and a layer 62 of active material, as shown in FIG. 6.

In another embodiment, shown in FIG. 7, layer 62 of active material may be disposed between graphite sheet 60 and current collector 56. In such embodiments, graphite sheet 60 may be perforated or in the form of a grid or screen, as shown in FIG. 7, in order to allow electrolyte to flow in communication with layer 62 of active material.

In another embodiment, shown in FIG. 8, plate 44 may include current collector 56, which may be formed of carbon foam layer 58, as in the embodiments shown in FIGS. 6 and 7. In the embodiment shown in FIG. 8, however, the thermally conductive material may be in the form of a graphite foam layer 64, which may also perform the functions of a current collector. Although not shown, other layers may be included in the embodiment of plate 44 shown in FIG. 8. For example, a layer of active material and/or a structural layer of inert material, e.g., polymer, may also be included between or external to the foam layers. Such a structural layer of inert material may also be included in any of the other embodiments disclosed herein.

The thermally conductive element may also be included in electrode plate configurations that do not include carbon foam current collectors. For example, a thermally conductive element, such as a graphite sheet, grid, foil, etc. can be placed in thermal communication with a traditional lead grid current collector of a traditional electrode plate for a lead-acid battery. Such a configuration may increase the thermal conductivity of the lead-based electrode plate and, therefore, more uniformly distribute the active regions of the electrode plate and improve the life of the battery.

The thermally conductive element, while being described as a graphite material may, alternatively or in combination, include other suitable materials. For example, the thermally conductive material may include various metals or diamond-like carbon films. In some embodiments, the thermally conductive element may include one or more materials that are more thermally conductive than lead and also exhibit at least some resistance to the environment of the battery. The material selected also should not inhibit the chemical reaction that provides the electrochemical potential of the battery.

### INDUSTRIAL APPLICABILITY

The presently disclosed embodiments of electrode plates may be applicable to any kind of battery having electrode plates that are subject to uneven thermal distribution. In particular, lead-acid batteries may benefit from the even thermal distribution provided by the disclosed electrode plates.

In some embodiments, even thermal distribution may be provided by flexible graphite sheeting incorporated into the electrode plate. Graphite has higher thermal conductivity than other structural electrode plate materials, such as lead. Also, graphite has a much lower density than other thermally conductive materials, such as lead. Accordingly, for a given weight, graphite distributes heat many times faster than other traditionally used electrode plate materials, such as, for example, lead.

Although, as discussed above, one type of flexible graphite sheeting which may be utilized in the disclosed embodiments is Grafoil™, any graphite sheeting or other material having the desired properties may be utilized. Graphite sheeting has the favorable characteristics of being lightweight, resistant to corrosion in batteries, and thermally conductive. Graphite sheeting also has the advantage of being an excellent thermal conductor parallel to the sheet, but not as thermally conductive perpendicular to the sheet. Therefore, graphite sheeting may evenly distribute thermal energy throughout the area of the plate, without unduly transferring large amounts of energy to the current collector at locations of initial high reactivity.

The disclosed electrode plates having thermally conductive materials may be utilized as negative and/or positive electrode plates, depending on the application. In some applications, such as lead-acid batteries, even thermal distribution in a negative plate may result in even thermal distribution in the positive plate as well, regardless of the materials used to make the positive plate, and vice versa.

It will be apparent to those skilled in the art that various modifications and variations can be made to the embodiments of electrode plates of the present disclosure without departing from the scope of the disclosure. Other embodiments will be apparent to those skilled in the art from consideration of the specification and practice of the electrode plates disclosed herein. It is intended that the specification and examples be considered as exemplary only, with a true scope of the disclosure being indicated by the following claims and their equivalents.

What is claimed is:

1. An electrode plate for a lead-acid battery, comprising:
a current-collecting first layer;
a second layer comprising flexible graphite sheeting and configured to distribute thermal energy within the electrode plate; and
a third layer, wherein the second layer is disposed between the current-collecting first layer and the third layer.

2. The electrode plate of claim 1, wherein at least one of the first and third layers comprises a carbon foam material.

3. The electrode plate of claim 1, wherein at least one of the first and third layers comprises a graphite foam material.

4. The electrode plate of claim 1, further including a lead grid layer adjacent to the second layer.

5. The electrode plate of claim 4, wherein the flexible graphite sheeting of the second layer includes a graphite grid, the alignment of the graphite grid being offset from the lead grid.

6. The electrode plate of claim 4, wherein the lead grid is configured to provide structural support for the electrode plate.

7. An electrode plate for a lead-acid battery, comprising:
a current-collecting, carbon foam first layer; and
a second layer formed of flexible graphite sheeting and configured to distribute thermal energy within the electrode plate.

8. The electrode plate of claim 7, wherein the second layer is disposed on an outer surface of the current-collecting, carbon foam first layer.

9. The electrode plate of claim 7, wherein the flexible graphite sheeting includes a perforated sheet or a grid.

10. The electrode plate of claim 9, further including a layer of chemically active material.

11. The electrode plate of claim 10, wherein the layer of chemically active material is disposed between the layer of flexible graphite sheeting and the current-collecting, carbon foam first layer.

12. The electrode plate of claim 10, wherein the chemically active material is an oxide of lead or a salt of lead.

13. The electrode plate of claim 7, further including a current-collecting third layer comprising graphite foam.

14. An electrode plate for a battery, comprising:
a current-collecting first layer; and
a second layer comprising flexible graphite sheeting and configured to distribute thermal energy within the electrode plate;
wherein the flexible graphite sheeting includes a perforated sheet or grid.

15. The electrode plate of claim 14, wherein the second layer is disposed on an outer surface of the current-collecting first layer.

16. The electrode plate of claim 14, wherein the current-collecting first layer comprises carbon foam.

17. The electrode plate of claim 14, further including a layer of chemically active material.

18. The electrode plate of claim 17, wherein the layer of chemically active material is disposed between the layer of flexible graphite sheeting and the current-collecting, carbon foam first layer.

19. The electrode plate of claim 17, wherein the chemically active material is an oxide of lead or a salt of lead.

20. The electrode plate of claim 14, further including a current-collecting third layer comprising graphite foam.
